(19) United States
(12) Patent Application Publication
(10) Pub. No.: US 2026/0216704 A1
(43) Pub. Date: Jul. 30, 2026

(54) SONOCHEMICAL SYNTHESIS METHODS AND RELATED APPLICATIONS

(71) Applicant: TEXAS TECH UNIVERSITY SYSTEM, Lubbock, TX (US)

(72) Inventors: Hannah Luera, Lubbock, TX (US); Sheima Khatib, Blacksburg, VA (US); Dominick Casadonte, Lubbock, TX (US)

(73) Assignee: TEXAS TECH UNIVERSITY SYSTEM, Lubbock, TX (US)

(21) Appl. No.: 19/148,978

(22) PCT Filed: Jan. 17, 2024
(86) PCT No.: PCT/US2024/011811

§ 371 Date: Jul. 17, 2025

Related U.S. Application Data
(60) Provisional application No. 63/439,326, filed on Jan. 17, 2023.

(51) Int. Cl. B01J 23/83; B01J 35/30; B01J 35/45; B01J 35/61; B01J 35/70; B01J 37/00; B01J 37/04; B01J 37/06; B01J 37/08; B01J 37/34; C01B 3/26

(52) U.S. Cl. CPC B01J 23/83; B01J 35/393; B01J 35/45; B01J 35/613; B01J 35/733; B01J 37/009; B01J 37/04; B01J 37/06; B01J 37/088; B01J 37/343; C01B 3/26; C01B 2203/0277; C01B 2203/1058; C01B 2203/1088; C01B 2203/1241

(57) ABSTRACT

Embodiments of the present disclosure pertain to a lanthanum nickel oxide (LaNiO₃) perovskite that includes a crystal structure with nickel oxide (NiO) inclusions. Additional embodiments of the present disclosure pertain to a method of forming the LaNiO₃ perovskites of the present disclosure by: (1) combining a lanthanum precursor and a nickel precursor to form a mixture; and (2) sonicating the mixture to form the LaNiO₃ perovskite. Additional embodiments of the present disclosure pertain to methods of using the LaNiO₃ perovskites of the present disclosure to catalytically convert hydrocarbons to hydrogen by exposing hydrocarbons to the LaNiO₃ perovskites of the present disclosure.

### CROSS-REFERENCE TO RELATED APPLICATIONS

This application claims priority to U.S. Provisional Patent Application No. 63/439,326, filed on Jan. 17, 2023. The entirety of the aforementioned application is incorporated herein by reference.

### BACKGROUND

A need exists for improved catalysts for facilitating catalytic methane decomposition (CMD) reactions without the production of carbon oxide-based by-products. Numerous embodiments of the present disclosure aim to address the aforementioned need.

### SUMMARY

In some embodiments, the present disclosure pertains to a lanthanum nickel oxide (LaNiO₃) perovskite that includes a crystal structure. In some embodiments, the crystal structure includes nickel oxide (NiO) inclusions.

Additional embodiments of the present disclosure pertain to a method of forming the LaNiO₃ perovskites of the present disclosure. In some embodiments, the methods of the present disclosure include: (1) combining a lanthanum precursor and a nickel precursor to form a mixture; and (2) sonicating the mixture to form the LaNiO₃ perovskite.

Additional embodiments of the present disclosure pertain to methods of using the LaNiO₃ perovskites of the present disclosure to catalytically convert hydrocarbons to hydrogen. Such methods generally include exposing hydrocarbons to the LaNiO₃ perovskites of the present disclosure. Thereafter, the LaNiO₃ perovskites catalytically convert the hydrocarbons to hydrogen.

### DESCRIPTION OF THE DRAWINGS

FIG. 1 shows a comparison of methane conversion data for conventionally prepared lanthanum nickel oxide (LaNiO₃) and LaNiO₃ prepared by the processes described in Example 1 (LIUT1, LIUT8 (▾3:1 ratio of SiC to catalyst), LIUT8 (1:1 ratio of SiC to catalyst), HIUT1, and HIUT8). Reaction conditions: temperature: 700° C.; feed: 20% CH₄ in N₂; GHSV: 30 L/g·h.

FIG. 2 shows methane conversion versus time on stream for a long reaction time for LIUT8 catalysts. Reaction conditions: temperature: 700° C.; feed: 20% CH₄ in N₂; GHSV: 30 L/g·h.

FIG. 3 shows temperature programmed surface reaction profiles for reference LaNiO₃, LIUT1, LIUT8, HIUT1, and HIUT8. Reaction parameters: temperature: 10° C./min ramp from room temperature to 800° C.; feed: 20% CH₄ in N₂, GHSV of 30 L/g·h.

FIG. 4 shows x-ray diffraction (XRD) patterns of fresh catalysts: LaNiO₃, LIUT1, LIUT8, HIUT1, and HIUT8.⋅NiO. ♥LaNiO₃.

FIG. 5 shows XRD pattern of activated catalysts: LaNiO₃, LIUT1, LIUT8, HIUT1, and HIUT8. ♦+Ni(0). □La₂O₃.×La(OH)₃.

FIG. 6 shows temperature programmed reduction (TPR) profiles of catalysts LaNiO₃, LIUT1, LIUT8, HIUT1, and HIUT8.

FIG. 7 shows XRD pattern of spent catalysts: LaNiO₃, LIUT1, LIUT8, HUIT1, and HIUT8. +Ni(0). [symbol] graphite. ∘SiC. ×La(OH)₃. □La₂O₃. □La₂(CO₃)O₂. *La₂CO₅.

FIG. 8 shows Raman spectra of spent catalytic samples.

FIG. 9 shows a comparison of differential thermal analysis (DTA) data for LaNiO₃, LIUT1, LIUT8, HIUT1, and HIUT8. Reaction conditions: the temperature was ramped to 1000° C. at 10° C./min with air flow at 50 ml/min.

FIGS. 10A-10D show scanning electron microscopy (SEM) micrographs and elemental mapping of activated catalysts, including a micrograph of a LaNiO₃ reference sample (FIG. 10A), Ni(0) mapping on LaNiO₃ (FIG. 10B), a micrograph of LIUT8 (FIG. 10C), and Ni(0) mapping on LIUT8 (FIG. 10D).

FIGS. 11A-11F show SEM micrographs and elemental mapping of spent catalysts (after 2 h TOS), including a micrograph of LaNiO₃ reference sample (FIG. 11A), C mapping on LaNiO₃ (FIG. 11B), Ni(0) mapping on LaNiO₃ (FIG. 11C), micrograph of LIUT8 (FIG. 11D), C mapping on LIUT8 (FIG. 11E), and Ni(0) mapping on LIUT8 (FIG. 11F).

FIGS. 12A-12E show SEM backscattering of spent LIUT8 after reaction times of 30 minutes (FIG. 12A), 1 hour (FIG. 12B), 2 hours (FIG. 12C), 15 hours (FIG. 12D), and spent LaNiO₃ after 2 hours (FIG. 12E).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose.

Despite being one of the main causes for emission of greenhouse gases into the atmosphere, burning of fossil fuels continues currently to be the main source of energy production due to the high availability of these fuels, their relatively low cost, and the already existing infrastructures necessary for their transportation from the source to the plants where they are converted. In an effort to decarbonize the future manufacturing industry, much focus is being placed by the scientific community on finding alternative renewable energy solutions that are less harmful to the environment and which can reduce dependence on fossil fuels. Within this context, hydrogen is considered a promising alternative energy carrier since it has the capacity to produce three times more energy than liquid hydrocarbons, and whether it is burnt directly or employed in fuel cells, it provides “clean” energy with no emission of pollutants.

However, hydrogen (H₂) is not directly available in nature and must be produced from other resources in a sustainable way to enable a transition to a “hydrogen economy” capable of meeting the world energy needs. Currently, the most common and economical processes for production of H₂ are steam reforming and partial oxidation of hydrocarbons, especially methane, which contains the highest H/C ratio. These routes, however, lead to high emissions of COₓ (about 13.7 kg CO₂/kg H₂ produced) and to mixtures of H₂ with small amounts of CO, requiring an additional separation step to reach the hydrogen purity required for fuel cells.

An alternative solution to produce clean hydrogen is the catalytic methane decomposition (CMD) process (CH₄ (g)→C(s)+H₂ (g), ΔH°₂₉₈=74.8 kJ/mol). The CMD process is a slightly endothermic reaction, which constitutes a direct methane conversion route to COₓ-free H₂ and solid carbon. Moreover, since the two main products are formed in different phases, separation costs are reduced. Furthermore, if the catalyst is capable of steering the reaction towards formation of structured nanocarbons, for example carbon nanotubes, in lieu of amorphous carbon, then the carbon product will also possess advantageous properties, including high mechanical strength, electronic and thermal conductivity with applications as electronic components, as polymer additives, for gas storage, and as catalytic support materials, thereby enabling in this way commercialization of the carbon side products. Deploying such a process as CMD is especially timely considering the availability of methane from shale gas and the need to convert it in stranded locations in order to reduce flaring, and importantly to aid in moving towards a more decarbonized future.

Commonly used catalysts for CMD are either metal-based (e.g., Ni, Co, Fe) or carbon-based materials. The former deactivate faster compared to the latter. However, the latter require higher activation energies and consequently higher operating temperatures.

Among the metal-based catalysts, Ni catalysts have been the most studied since they present the highest methane conversion and hydrogen yield. Ni-based catalysts are usually prepared as Ni oxide precursors which are activated under reducing conditions, leading to formation of metallic Ni particles that constitute the active phase in the CDM reaction.

There are multiple factors that affect the performance of Ni-based catalysts, such as the size of the Ni particles and the phase distribution, which are ultimately a result of the metal-support interaction. The latter is determined by the nature of the support, the presence of promoters, the preparation method, the activation, and reaction conditions. The metal-support interaction directly affects the reduction of the Ni oxide precursors and the dispersion of the reduced metallic species.

Deactivation of Ni-based catalysts is caused by formation of encapsulating carbon products that block access to metallic active sites. However, deactivation is not the main drawback for such catalysts because they can be regenerated by burning off the coke, even though such regeneration processes form COₓ. The major drawback of deactivation is that the process is also caused by irreversible sintering of the Ni sites. Therefore, the catalyst cannot maintain its activity over many reaction-regeneration cycles. A more robust catalyst is consequently necessary for operation under the harsh reaction conditions required for CMD.

A promising candidate of alternative CMD catalysts are the family of crystalline mixed oxides, such as Ni-based perovskites. These materials are stable at the extreme high temperature required for CMD and can lead to formation of dispersed metallic nanoparticles formed by exsolution of Ni from the perovskite network during reduction. The metal-support interaction remains strong enough that Ni mobility and consequent sintering is minimized. While perovskites have been studied amply as catalysts in dry methane reforming and reverse water gas shift, these materials have been less explored as catalysts in methane decomposition.

In sum, a need exists for improved catalysts for facilitating CMD reactions without the production of carbon oxide-based by-products. Numerous embodiments of the present disclosure aim to address the aforementioned need.

### Lanthanum Nickel Oxide (LaNiO₃) Perovskites

In some embodiments, the present disclosure pertains to a lanthanum nickel oxide (LaNiO₃) perovskite that includes a crystal structure. In some embodiments, the crystal structure includes nickel oxide (NiO) inclusions. As set forth in more detail herein, the LaNiO₃ perovskites of the present disclosure can have various structures, arrangements, and uses.

The LaNiO₃ perovskites of the present disclosure can have various surface areas. For instance, in some embodiments, the LaNiO₃ perovskites of the present disclosure have a surface area of less than about 23 m²/g. In some embodiments, the LaNiO₃ perovskites of the present disclosure have a surface area ranging from about 10 m²/g to about 22 m²/g. In some embodiments, the LaNiO₃ perovskites of the present disclosure have a surface area ranging from about 14 m²/g to about 21 m²/g. In some embodiments, the LaNiO₃ perovskites of the present disclosure have a surface area ranging from about 14 m²/g to about 15 m²/g. In some embodiments, the LaNiO₃ perovskites of the present disclosure have a surface area ranging from about 20 m²/g to about 21 m²/g.

The crystal structures of the LaNiO₃ perovskites of the present disclosure can have various crystal sizes. For instance, in some embodiments, the crystal structures include a crystal size of less than about 50 nm. In some embodiments, the crystal structures include a crystal size of less than about 30 nm. In some embodiments, the crystal structures include a crystal size of less than about 25 nm. In some embodiments, the crystal structures include a crystal size of less than about 23 nm. In some embodiments, the crystal structures include a crystal size of less than about 20 nm. In some embodiments, the crystal structures include a crystal size of less than about 17 nm. In some embodiments, the crystal structures include a crystal size ranging from about 10 nm to about 20 nm. In some embodiments, the crystal structures include a crystal size ranging from about 12 nm to about 16 nm.

The crystal structures of the LaNiO₃ perovskites of the present disclosure can have various NiO inclusions. For instance, in some embodiments, the NiO inclusions are within the crystal structure. In some embodiments, the NiO inclusions represent defects within the crystal structure. In some embodiments, the NiO inclusions represent nickel-rich regions within the bulk of the perovskite.

The LaNiO₃ perovskites of the present disclosure can have various uses. For instance, in some embodiments, the LaNiO₃ perovskites of the present disclosure are operable to convert hydrocarbons to hydrogen. In some embodiments, the LaNiO₃ perovskites of the present disclosure are operable to convert hydrocarbons to hydrogen without the formation of COₓ byproducts, such as CO₂ (x in COₓ represents an integer of 1 or higher).

In some embodiments, the LaNiO₃ perovskites of the present disclosure are a component of a catalytic conversion system. Additional embodiments of the present disclosure pertain to such catalytic conversion systems. In some embodiments, the catalytic conversion systems of the present disclosure include: (1) an inlet operable for receiving hydrocarbons; (2) a housing unit that includes the LaNiO₃ perovskites of the present disclosure, which are operable to convert the hydrocarbons to hydrogen; and (3) an outlet for outputting the formed hydrogen.

### Methods of Forming LaNiO₃ Perovskites

Additional embodiments of the present disclosure pertain to a method of forming the LaNiO₃ perovskites of the present disclosure. In some embodiments, the methods of the present disclosure include: (1) combining a lanthanum precursor and a nickel precursor to form a mixture; and (2) sonicating the mixture to form the LaNiO₃ perovskites. In some embodiments, the formed LaNiO₃ perovskite includes a crystal structure with NiO inclusions. As set forth in more detail herein, the methods of the present disclosure can have numerous embodiments.

The methods of the present disclosure can form various mixtures of lanthanum precursors and nickel precursors. For instance, in some embodiments, the mixture is in the form of a solution. In some embodiments, the mixture is in the form of an emulsion. In some embodiments, the mixture is in the form of a dispersion.

The methods of the present disclosure can utilize various types of lanthanum precursors. For instance, in some embodiments, the lanthanum precursor includes lanthanum nitrate La(NO₃)₃. In some embodiments, the La(NO₃)₃ includes La(NO₃)₃·xH₂O.

The methods of the present disclosure can utilize various types of nickel precursors. For instance, in some embodiments, the nickel precursor includes nickel nitrate Ni(NO₃). In some embodiments, the Ni(NO₃) includes Ni(NO₃)₂·6(H₂O).

Lanthanum precursors and nickel precursors may be mixed at various ratios. For instance, in some embodiments, the lanthanum precursor and the nickel precursor are mixed at a molar ratio of 1:1. In some embodiments, the lanthanum precursor and the nickel precursor are mixed at a molar ratio of 3:1.

The mixtures of the present disclosure may be sonicated for various periods of time. For instance, in some embodiments, the sonication occurs for a period of time ranging from about 30 minutes to about 24 hours. In some embodiments, the sonication occurs for a period of time ranging from about 30 minutes to about 10 hours. In some embodiments, the sonication occurs for a period of time ranging from about 1 hour to about 8 hours. In some embodiments, the sonication occurs for at least about 30 minutes. In some embodiments, the sonication occurs for at least about 1 hour. In some embodiments, the sonication occurs for at least about 8 hours.

The mixtures of the present disclosure may be sonicated at various ultrasound frequencies. For instance, in some embodiments, the sonication occurs at an ultrasound frequency ranging from about 10 kHz to about 200 kHz. In some embodiments, the sonication occurs at an ultrasound frequency ranging from about 10 kHz to about 100 kHz. In some embodiments, the sonication occurs at an ultrasound frequency ranging from about 20 kHz to about 50 kHz. In some embodiments, the sonication occurs at an ultrasound frequency of about 20 kHz. In some embodiments, the sonication occurs at an ultrasound frequency of about 47 kHz.

The mixtures of the present disclosure may be sonicated using various types of sonicators. For instance, in some embodiments, the sonication occurs using a direct immersion sonicator operating at 20 kHz. In some embodiments, the sonication occurs using an ultrasonic cleaning bath operating from about 20 kHz to about 100 kHz. In some embodiments, sonication occurs using a variable-frequency sonicator operating between 20 kHz to about 600 kHz.

The mixtures of the present disclosure may be sonicated at various ultrasonic power densities. For instance, in some embodiments, sonication occurs at an ultrasonic power density ranging from about 300 W/L and about 500 W/L. In some embodiments, sonication occurs at an ultrasonic power density ranging from about 400 W/L and about 500 W/L. In some embodiments, sonication occurs at an ultrasonic power density of at least about 300 W/L. In some embodiments, sonication occurs at an ultrasonic power density of at least about 350 W/L. In some embodiments, sonication occurs at an ultrasonic power density of at least about 400 W/L. In some embodiments, sonication occurs at an ultrasonic power density of about 425 W/L.

In some embodiments, sonication occurs at an ultrasonic power density ranging from about 1 W/L and about 50 W/L. In some embodiments, sonication occurs at an ultrasonic power density ranging from about 1 W/L and about 20 W/L. In some embodiments, sonication occurs at an ultrasonic power density of less than about 50 W/L. In some embodiments, sonication occurs at an ultrasonic power density of less than about 25 W/L. In some embodiments, sonication occurs at an ultrasonic power density of less than about 20 W/L. In some embodiments, sonication occurs at an ultrasonic power density of about 17 W/L.

### Methods of Catalytically Converting Hydrocarbons to Hydrogen

Additional embodiments of the present disclosure pertain to methods of using the LaNiO₃ perovskites of the present disclosure to catalytically convert hydrocarbons to hydrogen. Such methods generally include exposing hydrocarbons to the LaNiO₃ perovskites of the present disclosure. Thereafter, the LaNiO₃ perovskites catalytically convert the hydrocarbons to hydrogen. As set forth in more detail herein, the methods of the present disclosure can have numerous embodiments.

The methods of the present disclosure may expose hydrocarbons to LaNiO₃ perovskites in various manners. For instance, in some embodiments, the exposing includes flowing the hydrocarbons through LaNiO₃ perovskites. In some embodiments, the exposing includes incubating the hydrocarbons with the LaNiO₃ perovskites.

The methods of the present disclosure may be utilized to catalytically convert various hydrocarbons to hydrogen. For instance, in some embodiments, the hydrocarbon is in the form of a gas stream. In some embodiments, the hydrocarbon includes methane. In some embodiments, the method is used for catalytic methane decomposition (CMD).

In some embodiments, the LaNiO₃ perovskites of the present disclosure catalytically convert hydrocarbons to hydrogen without the formation of COₓ byproducts. In some embodiments, the LaNiO₃ perovskites of the present disclosure catalytically convert the hydrocarbons to hydrogen without the formation of CO₂. In some embodiments, the LaNiO₃ perovskites of the present disclosure catalytically convert hydrocarbons to hydrogen and structured carbon. In some embodiments, the structured carbon includes, without limitation, single walled carbon nanotubes, multiwalled carbon nanotubes, carbon nanofibers, or combinations thereof.

Without being bound by theory, the LaNiO₃ perovskites of the present disclosure catalytically convert hydrocarbons to hydrogen through various mechanisms. For instance, in some embodiments, NiO inclusions within the crystal structures of the LaNiO₃ perovskites facilitate the catalytic conversion of hydrocarbon to hydrogen by facilitating exsolution and migration of reduced Ni species to the surface of the crystal structures. In some embodiments, the NiO inclusions facilitate the catalytic conversion of hydrocarbons to hydrogen through the formation of a NiO—LaNiO₃ interface.

### Advantages and Applications

The LaNiO₃ perovskites and methods of the present disclosure can provide numerous advantages. In particular, the use of LaNiO₃ perovskites and methods of the present disclosure in catalytic methane decomposition is advantageous because H₂ can be produced without any emission of CO₂. Additionally, the use of LaNiO₃ perovskites and methods of the present disclosure eliminate difficult and costly gaseous separation processes necessary for pure H₂ production because COₓ by-products are not produced. Furthermore, the use of LaNiO₃ perovskites and methods of the present disclosure provide cost effective methods of catalytic decomposition because the starting products (e.g., Ni) are affordable and abundant. The use of LaNiO₃ perovskites is advantageous because they are thermally stable materials that are mechanically and thermally resistant.

In some embodiments, the LaNiO₃ perovskites and methods of the present disclosure can address concerns associated with coking, which generally pertains to formation of carbon structures on catalysts that lead to catalytic deactivation. In particular, in some embodiments, NiO inclusions within the crystal structures of the LaNiO₃ perovskites of the present disclosure prevent coking by preventing formed carbon structures from blocking the catalytic sites of the LaNiO₃ perovskites. As such, in some embodiments, the LaNiO₃ perovskites of the present disclosure may be able to maintain their catalytic activity for prolonged periods of time, such as more than 16 hours.

Accordingly, the LaNiO₃ perovskites and methods of the present disclosure have various advantageous applications. For instance, in some embodiments, the LaNiO₃ perovskites and methods of the present disclosure provide a high conversion catalyst that produces COₓ free H₂. In some embodiments, the LaNiO₃ perovskites and methods of the present disclosure enable the potential industrialization of catalytic methane decomposition (CMD), thereby replacing the greenhouse producing methane reforming currently in industry, which typically produces 10 tons of CO₂ for every 1 ton of H₂ produced. In some embodiments, the LaNiO₃ perovskites and methods of the present disclosure can be used to effectively eliminate two environmentally detrimental gases (CO₂ and CH₄) from the atmosphere.

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. Sonochemically Prepared Ni-Based Perovskites as Active and Stable Catalysts for Production of COₓ-Free H₂ and Structured Carbon

In this Example, applicant employs a sonochemical method to synthesize LaNiO₃ perovskites as catalysts for methane decomposition to produce clean COₓ-free H₂ and structured carbon. The catalytic activity of perovskites prepared under various sonochemical conditions (−intensity and exposure time) are contrasted with that of LaNiO₃ prepared by a conventional sol-gel method. Structural characterization of the as-prepared materials indicates that under certain sonochemical conditions (low-intensity sonication for eight hours) it is possible to introduce NiO inclusions in the crystal structure which are not present when employing the conventional synthesis technique. Upon activation of these materials under reducing conditions, it is found that the presence of the sonochemically-formed NiO inclusions facilitates exsolution and migration of the reduced Ni species to the surface of the catalyst particles, hence improving the catalyst activity in methane decomposition. The as-prepared catalysts showing coexistence of the LaNiO₃ and NiO inclusions also seem to exhibit autocatalytic properties as they steer the methane decomposition reaction towards formation of non-encapsulating carbon nanotubes which not only enhance catalyst stability but increase the catalyst activity over long reaction times.

Specifically, Applicant explores in this Example the differences in the catalytic behavior of Ni-based perovskites, LaNiO₃, prepared under different synthesis conditions that Applicant hypothesized would lead to different types of defects in the perovskite crystals. Without being bound by theory, Applicant posits that different defect types affect the reduction mechanism of the Ni sites as they exsolve during catalyst pre-reduction (i.e. activation), leading to different site distributions and active site-support interactions and interfaces, which ultimately will affect catalyst performance in CMD conditions.

To synthesize the LaNiO₃ catalysts with possible variations in the defect types, Applicant employed the sonochemical approach. Synthesis by sonochemistry offers the opportunity to modulate the ultrasound intensity, frequency, and exposure time, variables that are known to affect crystal surface properties, to acquire the desired material properties. It has been shown that sonochemical synthesis improves the morphology of the nanomaterials by smoothing and consolidating the particles. It has been determined that high-intensity ultrasound and low-intensity ultrasound modify different aspects of the resulting materials. While high-intensity ultrasound is known to change the chemical composition of materials due to the free radicals produced during the cavitation process as well as tribochemical interactions, low-intensity ultrasound is known to change the physical properties of nano-materials due to the mass transfer known to occur during cavitation.

The results Applicant presents herein contrasts the behavior of LaNiO₃ catalysts prepared under various ultrasound conditions, compared to a reference LaNiO₃ prepared by a conventional sol-gel (Pechini) method. Applicant analyzes the structures of these catalysts at different stages of reaction and show how different interfaces established by the synthesis procedure lead to different catalytic performances and importantly different stability in methane decomposition.

### Example 1.1. Catalyst Synthesis

Perovskite synthesis via sonication was conducted by dissolving stoichiometric amounts of the metal nitrate precursors of the respective metals (La(NO₃)₃·xH₂O and Ni(NO₃)₂·6(H₂O)) in 50 mL of deionized water. The solution was basified to a pH of 10, and then sonicated for 1 hour (T1) or 8 hours (T8) at either low-intensity ultrasound (LIU) or high-intensity ultrasound (HIU). The HIU sonicator was a Sonics and Materials Inc. Vibra-Cell 750W Direct Immersion sonicator. It was run at 45% amplitude and had an ultrasonic power density (measured by calorimetry) of 425W/L. Afterwards, the solution was centrifuged for 5 minutes, decanted, washed with water twice with intermediate centrifuging, and then washed with acetone. After a final centrifuging step, the acetone was decanted. The material was placed in a vacuum desiccator for 48 hours for drying. The powder was calcined at 800° C. for 2 hours. Catalysts were denoted by the time and type of sonication, for example: LIUT1 is perovskite LaNiO₃ synthesized at low intensity ultrasound for a time of 1 hour.

A perovskite prepared by a more conventional process was used to serve as reference to contrast with the samples prepared by the new sonochemical method. This reference perovskite was synthesized via Pechini synthesis, following a published procedure described herein: stoichiometric amounts of La(NO₃)₃·H₂O and of Ni(NO₃)₃·6(H₂O) were dissolved in distilled water and then mixed with a solution of citric acid and ethylene glycol (combined in equimolar amounts). The mixture was subsequently heated in a rotary evaporator to eliminate excess water. The samples were subsequently calcined in air from room temperature to 800° C. at 1° C./min and held at the final temperature for 5 hours. The perovskite synthesized by this method is denoted as LaNiO₃. A summary of all catalysts prepared along with the nomenclature used in this Example is presented in Table 1.

TABLE 1
Catalysts synthesized for this Example, along with
nomenclature and synthesis conditions. In this example,
high-intensity ultrasound has a power density of 425W/L and
low-intensity ultrasound has a power density of 17W/L,
as measured calorimetrically. High-intensity ultrasonic
power density can vary between 300W/L and 500W/L,
while low-intensity ultrasonic power density can range
between 1W/L and 50 W/L.

| | | Time of |
|---|---|---|
| Catalyst | Synthesis Method | Sonication |
| LaNiO₃ | Pechini method | — |
| LIUT1 | Low intensity ultrasound | 1 hour |
| LIUT8 | Low intensity ultrasound | 8 hours |
| HIUT1 | High intensity ultrasound | 1 hour |
| HIUT8 | High intensity ultrasound | 8 hours |

### Example 1.2. Catalyst Structural Characterization

Example 1.2.1. N₂ adsorption-desorption isotherms to determine catalyst surface area. The surface area of the catalyst was measured by N₂ physisorption at liquid N₂ temperature (−196° C.) using an Anton Paar Quantachrome Autosorb iQ instrument. Samples were outgassed at 300° C. for 5 hours to remove any moisture prior to measurements. Adsorption isotherms were then recorded as a function of relative pressure and specific volume of nitrogen adsorbed at standard temperature and pressure (STP). The surface area of the samples was determined using the Brunauer-Emmett-Teller (BET) method.

Example 1.2.2. Powder X-ray diffraction (PXRD). The powder X-ray diffraction (PXRD) data were collected on a Rigaku Ultima III powder diffractometer. X-ray diffraction patterns were obtained by scanning a 20 range of 5-80° with a step size=0.02°, and scan time of 1.6 min/degree. The X-ray source was Cu Kα radiation (λ=1.5418 Å) with an anode voltage of 40 kV and a current of 44 mA. The beam was then discriminated by Rigaku's Cross Beam parallel beam optics to create a monochromatic parallel beam. Diffraction intensities were recorded on a scintillation detector after being filtered through a Ge monochromator. The Debye-Scherrer equation (Equation 1), was used to calculate the Ni(0) crystallite sizes in the activated and spent samples.

$$D = \frac{k λ}{β cos θ} \qquad ( 1 )$$

In Equation 1, D is the crystalline size of the particle, K is the Scherrer's constant, A is the X-ray wavelength, B is the full width at half maximum of the diffraction peak, and θ is the Bragg angle. Jade software was utilized to calculate the full-width half-maximum (FWHM) and estimate the amount of Ni(0) present in the activated samples in weight percent. XRD patterns for each sample were acquired three times to calculate average crystallite sizes and the associated standard deviations. Since SiC was used as a diluent in the catalyst bed, the SiC pattern was subtracted from the patterns of the spent catalysts.

Example 1.2.3. Temperature programmed reduction (TPR). The temperature programmed reduction (TPR) profiles were measured employing an Anton Paar Quantachrome Autosorb iQ instrument. For all experiments, approximately 35 mg of sample were loaded into a y-cell and heated to 250° C. under helium flow to remove moisture. The samples were then cooled to room temperature, and the flowing gas was switched to hydrogen (5% H₂/95% N₂) at a flow rate of 45 mL/min. The temperature was ramped to 900° C. at 10° C./min, while the water production was tracked using a Prisma Plus QME220 mass spectrometer.

Example 1.2.4. Thermogravimetric analysis (TGA) and differential thermogravimetric analysis (DTA). Thermogravimetric analysis (TGA) of the activated catalysts was carried out using a Shimadzu DTG-60H simultaneous DTA-TG apparatus. In all cases a blank reference crucible was simultaneously heated with a sample containing crucible in nitrogen flow of 100 mL/min from 25° C. to 1000° C. at a heating rate of 10° C./min. Each crucible contained approximately 10 mg of sample.

TGA of the spent catalysts (after undergoing three hours of reaction) was carried out using a Mettler TGA/SDTA851e instrument. In all the cases, a blank crucible was heated in an air flow of 50 ml/min from 25° C. to 1000° C. at a heating rate of 10° C./min. The crucible was then charged with approximately 20 mg of sample and heated in the same way as the blank crucible. The weight change profile of the sample was obtained by subtracting the blank crucible profile from the sample profile. Differential thermal analysis (DTA) was then performed on the TGA profiles by taking the 1st derivative of the TGA curves.

Example 1.2.5. Raman spectroscopy. Raman spectroscopy was used to evaluate the formation and structure of carbon nanomaterials produced on the spent catalysts by the CMD reaction. The spectra were recorded using a Renishaw in Via Raman microscope with a He—Ne laser (532 nm) and 8 mW power. Different regions of the sample were measured to account for any inhomogeneity in the samples.

Example 1.2.6. Scanning electron microscopy with energy dispersive spectroscopy (SEM-EDS). Scanning electron microscopy-energy dispersive spectroscopy (SEM-EDS) was used to analyze the morphology and elemental composition of activated and spent catalysts. Images were collected on a Hitachi TM4000Plus Tabletop Microscope at magnifications of 5.35.

### Example 1.3. Catalyst Reactivity

Example 1.3.1. Isothermal reactions. Isothermal reactivity measurements were performed in a packed-bed quartz reactor with an O.D. of 9 mm. The catalyst was diluted with inert SiC, using a 1:1 of catalyst to SiC. All catalysts were activated by flowing a 30% H₂ 70% N₂ gas mixture at 30 mL/min through the reactor as the temperature was ramped from room temperature to 700° C. at 10° C./min and then held for one hour at setpoint. For reaction, the flow was then switched to a mixture of 20% methane 80% nitrogen at a gas hourly space velocity (GHSV) of 30 L/g·h to ensure operation under kinetic regime conditions. All gases exiting the reactor were analyzed online with an Agilent gas chromatograph equipped with 0.4 m HayeSep A and a 5′ HayeSep A to a positive polarity thermal conductivity detector (TCD); a 3′ HayeSep Q column and a 8′ molecular sieve to a negative polarity TCD; and a CP-Sil 5 CB to a flame ionization detector (FID). The methane conversion was calculated according to Equation 2.

$$X = \frac{{CH}_{4 t} - {CH}_{4 f}}{{CH}_{4 i}} \times 100 \qquad ( 2 )$$

In Equation 2, X is the conversion, CH4i represents the amount of initial methane at the reactor inlet, and CH4f represents the unreacted methane detected at the reactor exit.

Example 1.3.2. Temperature-programmed surface reaction (TPSR). Temperature programmed surface reaction (TPSR) measurements were performed in the same reactor and under the same conditions used for the isothermal activity tests described above. Before reaction, a GHSV of 15 L/g·h was set with a gas flow of 20% methane 80% nitrogen and the temperature was ramped to 800° C. at 10° C./min, while the gases exiting the reactor were analyzed using an MKS Cirrus 3 mass spectrometer connected online to the reactor. All measured partial pressures of hydrogen were normalized to the pressure of the inert nitrogen to enable comparisons across experiments.

### Example 1.4. Results and Discussion

Example 1.4.1. Catalytic activity. To determine whether the sonochemical synthesis method produces LaNiO₃ with enhanced catalytic activity in CMD, compared to conventionally prepared LaNiO₃ by the Pechini sol-gel method, all samples from Table 1 were tested in reaction under isothermal conditions at 700° C. It is known that catalysts active in CMD usually operate optimally within the 500° C. to 700° C. temperature range, and specifically for the reference LaNiO₃ prepared by the Pechini method, it has been determined that the optimum reaction temperature is 700° C. Therefore, Applicant chose this temperature to contrast activity of all the catalysts in the isothermal reaction experiments.

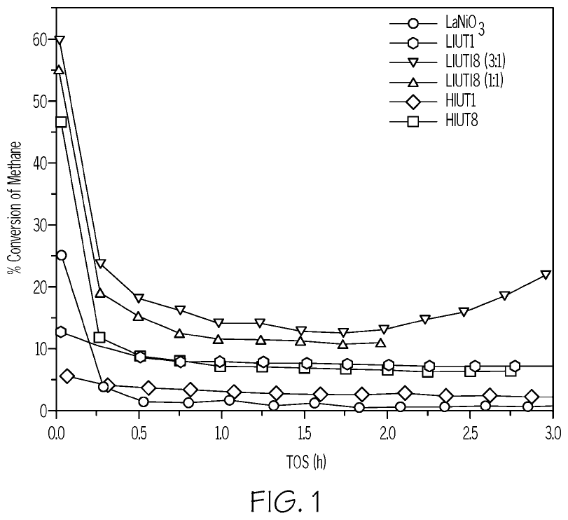

The activity results are shown in FIG. 1 in the form of methane conversion versus time on stream. Since the sole product Applicant detected in the gas phase was hydrogen, Applicant can confirm that hydrogen yield values would show the same trends observed with methane conversion.

In FIG. 1, Applicant observed that the reference LaNiO₃ catalyst shows an initial CH₄ conversion of around 25%, which quickly drops to less than 5% within an hour of reaction. The catalysts prepared by the sonochemical method exposed to a sonication time of one hour, LIUT1 and HIUT1, exhibit a lower initial CH₄ conversion (13% and 5% respectively) but this conversion does not drop in the same extent as that of the reference LaNiO₃. Therefore, over time, these catalysts are more active and yield more hydrogen than the reference sample.

The samples exposed to a longer sonication time of eight hours, LIUT8 and HIUT8, show higher methane conversion than the reference sample during the entire reaction period. The initial methane conversion values are much higher with 55% conversion for LIUT8 and 46% for HIUT8. However, as in the case of the reference sample, the conversion of both samples drops drastically within the first 15 minutes of reaction, reaching a stable value of around 11% and 6% respectively.

The results obtained with LIUT8 are noteworthy, as among all the catalysts, this one shows the highest methane conversion over reaction time. However, after two hours, LIUT8 stops converting CH₄ and produces H₂ very suddenly. This change happened at the same time that there was a drastic increase in reactor pressure by 15 psi caused by reactor clogging, presumably due to formation of carbon deposits. To remedy this issue, the catalyst bed was diluted by employing a higher ratio of SiC to LIUT8 (3:1) while maintaining the same GHSV. This change overcame reactor clogging and allowed the catalyst to maintain a conversion of around 12% (closed triangles in FIG. 1) for two hours. After two hours, the conversion gradually increases for the remainder of the reaction time, showing a catalytic performance that is superior in activity and stability to all the other catalysts.

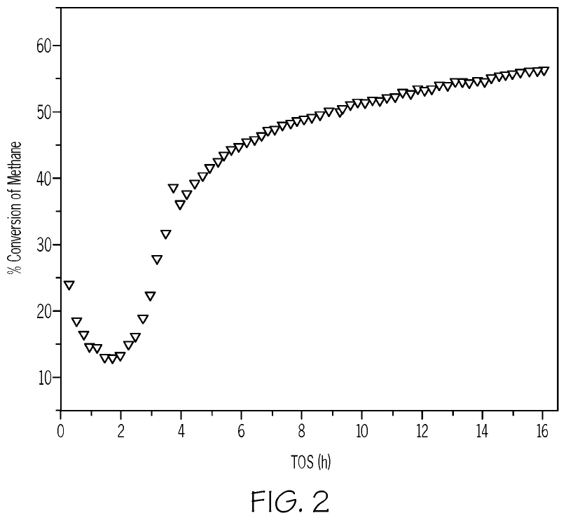

A separate isothermal reaction experiment was run to test the stability of the LIUT8 catalyst over a longer period of time (FIG. 2), showing that after the initial drop in methane conversion within the first two hours of reaction, the conversion continuously increases, rapidly at first, reaching a maximum of around 50% CH₄ conversion within eight hours of reaction, at which point it continues to increase but at a slower rate for up to 16 hours of time on stream. This continuous production of H₂ over 16 hours of reaction without significant deactivation is unusual as most metal-based catalysts employed under the harsh CMD reaction conditions deactivate within a few hours of reaction.

The result with LIUT8 suggests that the carbon formed in the reaction is not encapsulating the active Ni sites, allowing them to maintain their activity for long periods of time. The reason for the initial drop in methane conversion followed by a subsequent rise in conversion can be understood better upon structural characterization of this catalyst and will be discussed in the following sections. The long catalyst life observed here is encouraging for the possible future deployment of methane decomposition for production of COₓ-free hydrogen.

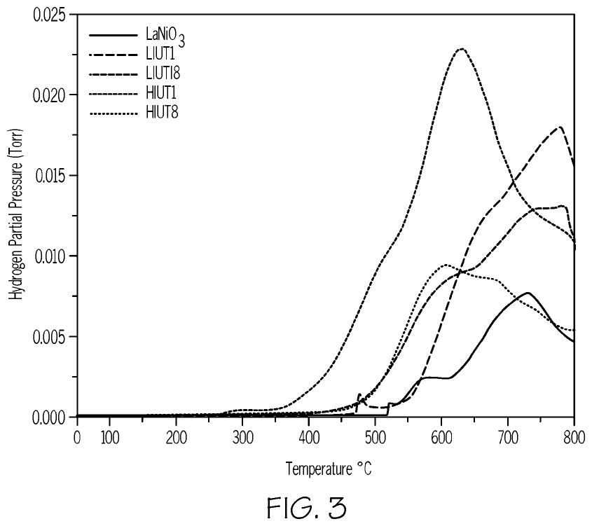

To further contrast the relative activity of these catalysts at different temperatures, temperature-programmed surface reaction (TPSR) measurements were performed with all the catalysts. FIG. 3 shows profiles of hydrogen partial pressure versus temperature. The reference LaNiO₃ catalyst exhibits the highest hydrogen onset temperature at approximately 500° C., which is in agreement with previous work using the same Pechini method to prepare this catalyst. All other catalysts prepared by the sonochemical method are more active, with onset temperatures below 460° C. The LIUT1 catalyst activates at about 450° C. Both sonochemical catalysts with longer sonication times, HIUT8 and LIUT8 exhibit a significantly lower activation temperature at 350° C., while the HIUT1 catalyst exhibits the lowest onset temperature, at 250° C., proving to be the most active catalyst. The more active sonochemical catalysts, LIUT8, HIUT8, and HIUT1, were tested under isothermal conditions at 500° C. and the results show that while the catalysts present a lower initial methane conversion compared to that obtained when the reactions are run at 700° C., this conversion stabilizes for up to six hours. At the lower reaction temperature, once again LIUT8 shows the highest catalytic activity and stability. These results demonstrate that the perovskite catalysts prepared by the sonochemical method are capable of operating at lower temperatures while still yielding hydrogen product and remaining stable over long periods of time under harsh reaction conditions.

In summary, the catalysts prepared by sonication demonstrate superior performance both in methane conversion (and consequent hydrogen yield) and stability when compared to the LaNiO₃ perovskite synthesized by the Pechini method. To better understand the structure-activity relations that could explain the different catalytic behavior as a function of the synthesis method and conditions, Applicant characterized the structures of all the as-prepared, pretreated (reduced), and spent catalysts.

### Example 1.5. Structural Characterization of as-Prepared and Activated Catalysts

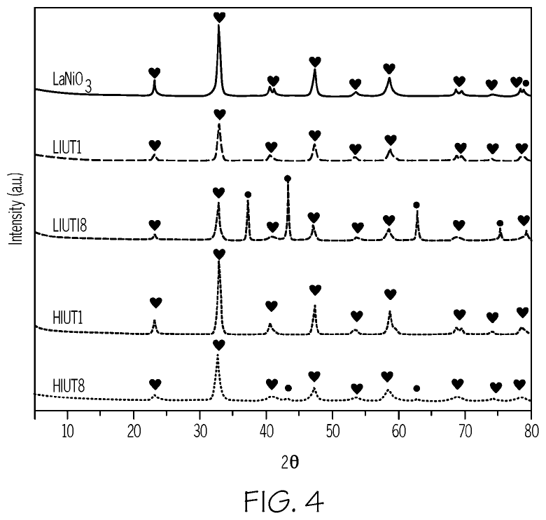

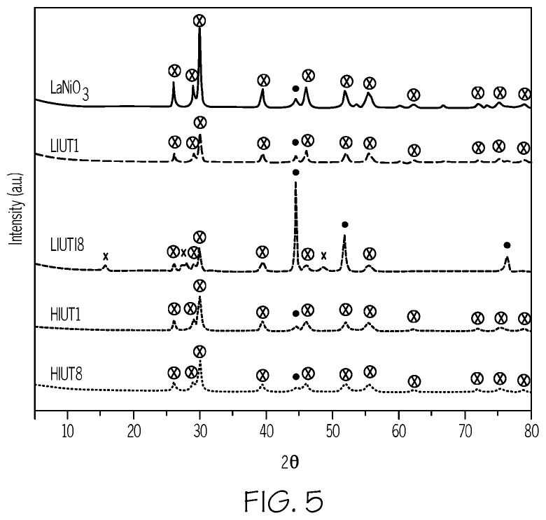

To analyze the crystalline phases present in the samples, XRD was performed on the as-prepared and activated catalysts. The diffraction patterns are shown in FIGS. 4-5. All the fresh, as-prepared catalysts (FIG. 4) exhibit peaks corresponding to a LaNiO₃ phase, with features at 2θ values of 23.2°, 32.8°, 40.8°, 47.2°, 53.7°, 58.5°, 69.2°, and 78.6° (ICDD 00-033-0711), confirming that indeed the perovskite phase was formed successfully at the synthesis conditions employed in each case.

However, not all samples constitute pure LaNiO₃. For instance, LIUT8 shows additional sharp peaks at 2θ of 37.2°, 43.3°, 62.9°, 75.3°, and 79.3° corresponding to a NiO phase (ICDD 98-000-0133). HIUT8 also exhibits these NiO peaks but they are much weaker indicating smaller NiO phases present in this sample compared to LIUT8. The overall trends in the XRD patterns suggest that longer sonication times lead to a certain degree of segregation of NiO from the LaNiO₃ crystalline phase.

TABLE 2
Crystal sizes for LaNiO₃ in as-prepared catalysts, and
Ni(0) in activated and spent catalysts.

| | LIUT1 | LIUT8 | HIUT1 | HIUT8 | LaNiO₃ |
|---|---|---|---|---|---|
| LaNiO₃ | 29.3 | 15.3 | 30.2 | 12.7 | 23.6 |
| Crystal Size in | | | | | |
| as-Prepared | | | | | |
| Catalysts (nm) | | | | | |
| Ni(0) Crystal | 13.7 | 12.5 | 9.6 | 6.8 | 11.4 |
| Size in | (±5.6) | (±1.6) | (±1.8) | (±0.7) | (±2.4) |
| Activated | | | | | |
| Catalyst (nm) | | | | | |
| Ni(0) Crystal | 25.2 | 39.3 | 10.9 | 10.5 | 37.6 |
| Size in Spent | (±6.2) | (±18.0) | (±2.1) | (±2.8) | (±2.5) |
| Catalyst (nm) | | | | | |

The perovskite crystallite sizes were calculated and are shown in the first row of Table 2. The catalysts prepared by sonication with lower times of sonication (1h) show slightly larger crystal sizes (29.3 nm for LIUT1 and 30.2 nm for HIUT1) compared to that of the reference LaNiO₃ sample (23.6 nm). Yet, extending the sonication time to 8 hours shows an approximately 50% drop in crystal size, to 15.3 and 12.7 nm for LIUT8 and HIUT8 respectively. It is precisely the LIUT8 catalyst, which possesses the smallest LaNiO₃ crystal sizes and the coexistence of large NiO crystals, that also exhibits the highest methane conversion and stability throughout the reaction time (FIG. 1).

Without being bound by theory, the results in Table 2 suggest that the NiO—LaNiO₃ interface might play a role in enhancing catalytic activity in this system. Considering that the activated catalyst is reduced, it is more relevant to analyze how these interfaces could affect the size, location, and distribution of the reduced Ni particles formed after reductive pretreatment (i.e. activation) of the catalyst.

The XRD patterns of the activated catalysts are shown in FIG. 5. These patterns result from as-prepared samples being exposed to reduction conditions, as described in Example 1.1., in order to activate them for reaction. It is observed that all the samples contain reduced Ni(0) crystals with 2θ peaks at 44.5°, 51.9°, and 76.4° (ICDD 04-003-7263). In all the samples peaks corresponding to La₂O₃, at 2θ values 26.1°, 29.1°, 30.0°, 39.5°, 46.0°, 55.9°, 62.2°, 72.0°, 75.3°, and 79.2° (ICDD 04-005-4229) are also observed. In other words, during reduction, metallic Ni exsolves to form Ni particles supported on La₂O₃. In the case of the LIUT8 catalyst, La(OH)₃, with peaks at 2θ of 15.6°, 27.3°, and 30.0° (ICDD 04-016-2501), is also detected. The Ni crystal sizes after activation, shown in the second row in Table 2, indicate that the exsolved Ni crystals formed in the reference LaNiO₃ and low intensity sonicated catalysts, LIUT1 and LIUT8, possess similar particle sizes, within the 11-13 nm range, while the high intensity catalysts, HIUT1 and HUIT8, present smaller exsolved Ni particles.

Usually, smaller crystal sizes of the active phase result in higher catalytic activity, however, this correlation is not observed here, as the most active catalyst, LIUT8, in fact possesses the larger Ni crystals (12.5 nm) after activation. However, it should be noted that LIUT8 also presents some heterogeneity in size distribution of the Ni phase, as evidenced by the relatively large standard deviation value shown in brackets. This is not surprising considering that these reduced phases must have originated from two different sources: (1) larger NiO crystallites present in the as-prepared catalyst, and (2) exsolved from the LaNiO₃ structure. The latter would form smaller Ni nanoparticles, which would probably contribute more to the reaction due to their inherent higher dispersion.

The question remains as to how the initial NiO—LaNiO₃ interfaces could play a role in the reactivity and stability of the resulting reduced Ni particles. To delve deeper into this question, the differences in the reducibility of the Ni oxide species within the crystalline structures of the as-prepared catalysts was analyzed via temperature programmed reduction (TPR) measurements. Without being bound by theory, Applicant posits that differences in reducibility of particles could influence the mechanism of exsolution of Ni from the LaNiO₃ crystal during reduction, and affect the size, morphology, as well as availability of the exsolved Ni nanoparticles on the external surface of the support, consequently impacting the resulting catalyst performance.

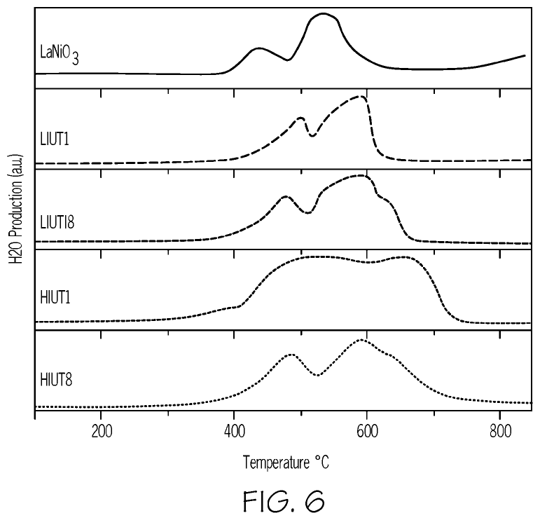

The TPR profiles of the fresh, as-prepared catalysts are presented in FIG. 6. There are clearly differences in the profiles as a function of synthesis conditions. While the reference LaNiO₃ catalyst prepared by the Pechini method shows two peaks centered at 435° C. and 547° C., typical of TPR profiles found in the literature for LaNiO₃, all the catalysts prepared by the sonochemical method show more complex profiles, with broader peaks that are shifted to higher temperatures.

The profiles of the sonicate catalysts suggest a stronger Ni-support interaction which hinders reduction of Ni. The broader peaks also suggest coexistence of different Ni sites with a distribution of reduction, which potentially undergo different reduction pathways. In the case of LIUT8 and HIUT8, the XRD patterns showed coexistence of two Ni phases, namely NiO and LaNiO₃. The presence of the NiO in these two samples explains the higher relative intensity of the low temperature peak (around 475° C.) in the TPR profiles, as it is known that the TPR profile of free, unbound NiO species show a reduction peak around this temperature. However, even in the samples where coexistence of multiple phases was not detected by XRD, Applicant cannot discard the presence of different types of Ni sites (that are too small to be detected by XRD) existing at different types of defects.

In a detailed examination involving a combination of advanced characterization and imaging techniques, a prior study compared the structures of LaNiO₃ samples prepared by two different methods, namely co-precipitation, and hydrothermal method, and they determined by XRD that each synthesis method led to the same LaNiO₃ phase, but through microscopic imaging they found that each sample presented different types of structural defects, which seemed to influence the reduction pathways for the two materials. The study demonstrated that, depending on the types of defects present in the crystals, reduction happened either via a two-step process (showing two TPR peaks):

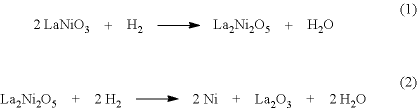

or a three-step process (three TPR peaks):

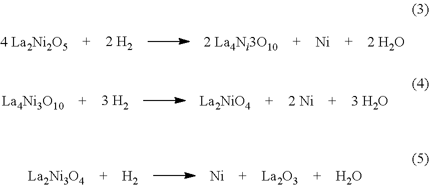

The insight from this research is relevant to this Example as Applicant is exploring LaNiO₃ prepared under different sonication conditions, which could lead to different types of defects in the crystalline structures, that are undetectable by XRD. Differences in defect types are plausible considering that Applicant's samples present differences in their catalytic behavior in CMD as a function of varying the sonication intensity and time. This is especially evident in the case of LIUT8, and to a certain extent HIUT8, where NiO phases are detected (FIG. 5) in conjunction with the LaNiO₃ crystals.

The coexistence of these phases invariably results in the presence of NiO-perovskite interfaces that are absent in the rest of the samples. Previous work has also shown that the formation of defects in the form of NiO inclusions in LaNiO₃ crystals constitute areas for Ni enrichment during reduction in hydrogen. Such a phenomenon is possibly occurring in Applicant's LIUT8 catalyst during reduction, highlighted by the large Ni crystals detected by XRD.

Another way of indirectly proving the coexistence of different types of Ni species is via calculation of the relative areas under the TPR peaks. According to the stoichiometry in the two-step reduction process described by equations (1) and (2), the area under the higher temperature TPR peak should be two times larger than the area under the lower temperature peak. Applicants observe that, with the exception of LIUT8 and HIUT8, this ratio is not fulfilled in the profiles of the catalyst samples. The XRD patterns clearly indicate that two phases coexist in these two samples, therefore the fulfilment of the 2:1 ratio in the TPR profiles is not indicative of reduction of only one Ni oxide species. Furthermore, none of the profiles, including those of LIUT8 and HIUT8 clearly delineate 2- or 3-peak profiles, further underpinning coexistence of different types of Ni centers with different reducibility and possibly coexistence of different reduction pathways resulting from existence of different types of structural defects in the different samples.

To account for possible trends in the surface areas of the catalysts that could account for the differences in their activity, Applicant analyzed the surface areas of all the as-prepared and activated catalysts by measuring N₂ adsorption/desorption isotherms. The calculated BET surface areas are shown in Table 3.

TABLE 3
BET measurements of surface areas
of the Ni-based catalysts prepared by
different synthesis methods.

| | BET area of as- | BET area of |
|---|---|---|
| | prepared | activated |
| Catalysts | catalyst (m²/g) | catalyst (m²/g) |
| LaNiO₃ | 23.33 | 15.59 |
| LIUT1 | 15.96 | 14.99 |
| LIUT8 | 27.98 | 30.51 |
| HIUT1 | 14.65 | 13.41 |
| HIUT8 | 20.55 | 15.25 |

The reference LaNiO₃ catalyst did not possess a significantly different surface area compared to the sonicated materials. Within the series of sonicated catalysts, it was observed that longer sonication time (from one hour to eight hours) in the synthesis procedure led to slightly higher surface areas as is evidenced by the higher surface areas measured for LIUT8 and HIUT8 compared respectively to LIUT1 and HIUT1. The one-hour sonicated catalysts, LIUT1 and HIUT1, did not undergo significant changes in surface area after activation in hydrogen (activated samples), but LaNiO₃ and HIUT8 did undergo a small drop in surface area, while LIUT8 underwent a slight increase in surface area, showing an area that was around two times higher than all the other activated catalysts.

It is known that in some cases, when the Ni exsolves from LaNiO₃ to form Ni, the resulting La₂O₃ support can become more porous, resulting in a higher surface area. The higher porosity of the support could be a result of the easier mobility of the exsolved Ni to the defects where they can be exposed to the methane reactant and lead to higher conversion values obtained with LIUT8. The higher availability of exsolved metallic Ni on the external surface of the catalyst particle could explain the higher catalytic performance of LIUT8.

Overall, characterization of the physico-chemical properties of the as-prepared and activated catalysts suggests that the presence of NiO inclusions in the LaNiO₃ structure, formed as a result of the sonication conditions, could facilitate easier migration and consequent enrichment of exsolved Ni on the catalyst particle surface, leading to higher catalytic activity. To better understand the effect of the catalyst structure on its stability in reaction, Applicant also characterized the spent catalysts.

### Example 1.6. Structural Characterization of Spent Catalysts

Without being bound by theory, the mechanism of deactivation of Ni-based CMD catalysts occurs via a two-pronged process: sintering of the active metallic Ni nanoparticles and deposition of encapsulating carbon. To deconvolute the role that each of these phenomena play in the deactivation of the catalysts, in this Example Applicant characterized the spent catalysts by XRD to calculate changes in Ni particle size, and by a combination of TGA-DTA, SEM-EDS, and Raman spectroscopy to monitor the carbon structures formed in reaction.

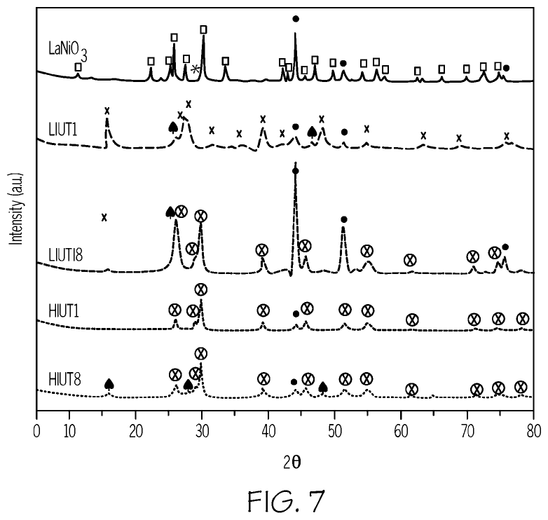

The XRD patterns of the spent catalysts exhibit the same Ni and La₂O₃ diffraction peaks (FIG. 7) that were present in the reduced catalysts (FIG. 5), but the most active catalyst, LIUT8, also shows an additional intense peak at 2θ of 26° corresponding to graphite (ICDD 01-073-5918). The absence of this peak in the patterns of the other spent catalysts cannot be used as a justification to discard the presence of carbon in those samples, which would probably possess either amorphous carbon deposits invisible to XRD, or very small undetectable amounts, given their lower overall activity. In the case of the spent reference LaNiO₃, interestingly the La₂O₃ peaks disappear, and instead peaks corresponding to lanthanum carbonates, La₂(CO₃)O₂ (ICDD 00-023-0320) and La₂CO₅ (ICDD 04-012-3839) are detected. This indicates that there was a strong interaction between the carbon formed during the reaction and the La₂O₃ support leading to the formation of carbonate species. It is possible that these carbonate species could contribute to catalyst deactivation by interfering with the Ni—La₂O₃ interactions.

The crystal sizes of the Ni particles in the spent catalysts were also calculated and are shown in the third row in Table 2. When contrasting the crystal sizes in activated and spent samples in the second and thirds rows of Table 2, it is evident that all catalyst samples exhibit an increase in the average Ni(0) crystal size during reaction, suggesting that sintering occurs in all cases. This sintering would explain the initial drop in catalytic activity for all the samples. Usually, higher extent of sintering correlates with faster catalyst deactivation and this explains the much lower stability of the reference LaNiO₃ compared to the sonicated catalysts. This correlation is not observed with the most stable catalyst, LIUT8, which showed a significant extent of sintering, but continued to remain active for a longer period of time. However, it is important to note that precisely this catalyst did not show an even distribution of Ni particle sizes in the spent sample, given the large standard deviation that was calculated based on three different measurements.

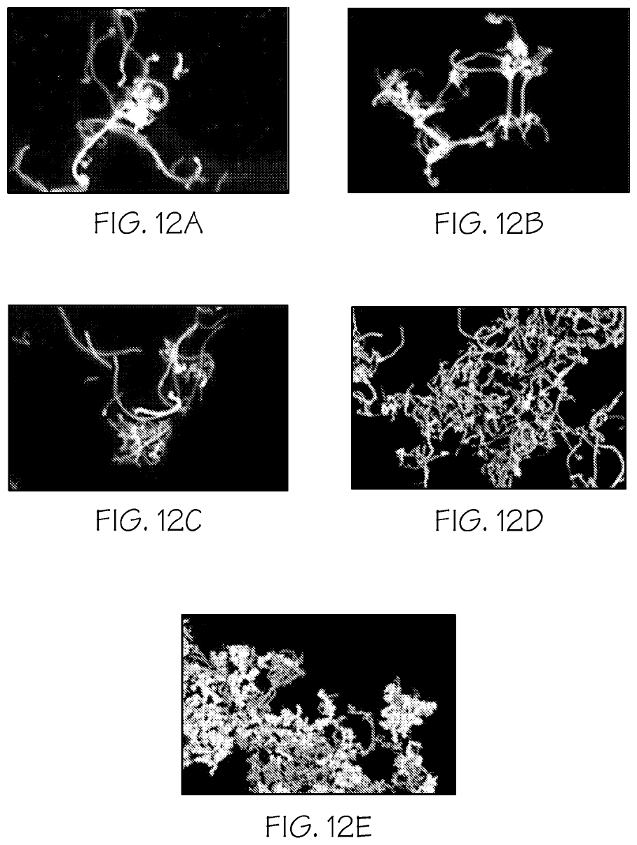

The heterogeneity in Ni particle sizes was corroborated through SEM imagining to be discussed later (FIGS. 12A-12E). Thus, it is possible that sintering was occurring mainly with the larger Ni particles originating from reduction of the NiO phase, while smaller, more dispersed Ni clusters formed by exsolution from the LaNiO₃ phase showed stronger interactions with the support and were capable of remaining dispersed and active, maintaining the higher methane conversion over a prolonged period of time.

The degree of sintering alone does not explain the deactivation trends observed with Applicant's catalysts, especially pertaining to LIUT8, where over time, catalyst activity resurged. To better understand the differences in the stability of the catalysts, the carbon deposits formed after the reaction in the spent samples were also characterized.

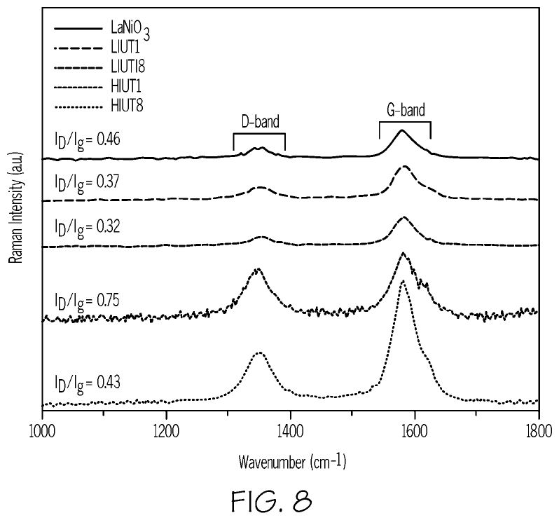

Raman spectroscopic studies were conducted in order to identify the types of carbonaceous species formed in reaction and the spectra are displayed in FIG. 8. All spent samples exhibit two Raman bands at approximately 1350 and 1590 cm-1 assigned to the D and G bands respectively, where the D-band feature is typically assigned to disordered aromatic carbon deposits, and the G-band is assigned to ordered graphitic carbon deposits. The I_{d}/I_{g} ratios were calculated to reflect the degree of disorder in the carbon deposits, where higher values are indicative of higher extent of disorder. The I_{d}/I_{g} ratios (also presented in FIG. 8) indicate that the carbon deposits formed on catalysts prepared sonochemically at low intensity show a lower degree of disorder compared to the reference LaNiO₃ catalyst, while the carbon formed on the catalysts prepared at higher intensity possess a higher degree of disorder.

When contrasting these results with the activity data in FIG. 1, in general, a higher degree of order in the carbon deposits (graphitic carbon) coincides with a higher catalyst activity, and this is especially evident in the case of LIUT8 which shows carbon with the lowest degree of disorder, aligning with the XRD result where this catalyst clearly showed an intense graphitic peak which was absent in the patterns of all other spent catalysts. In other words, the ordered carbon structures formed on LIUT8 resulting from CMD do not seem to be encapsulating the active Ni sites.

The carbon formed on the catalysts was also analyzed by thermogravimetric analysis in conjunction with differential analysis (TGA-DTA). The TGA profiles were used to calculate the amount of carbon deposited after three hours of reaction for each catalyst (Table 4).

TABLE 4
Amount of carbon detected by TGA on catalysts after
3 h of reaction.

| | LaNiO₃ | LIUT8 | LIUT1 | HIUT8 | HIUT1 |
|---|---|---|---|---|---|
| mg carbon | 0.11 | 0.52 | 0.11 | 0.25 | 0.17 |
| per mg | | | | | |
| catalyst | | | | | |

As expected, the catalysts that showed higher methane conversion values over 3 hours of reaction also possessed larger quantities of carbon. DTA obtained from the TGA profiles was used to provide an idea of how many different species of carbon are present during the removal of carbon.

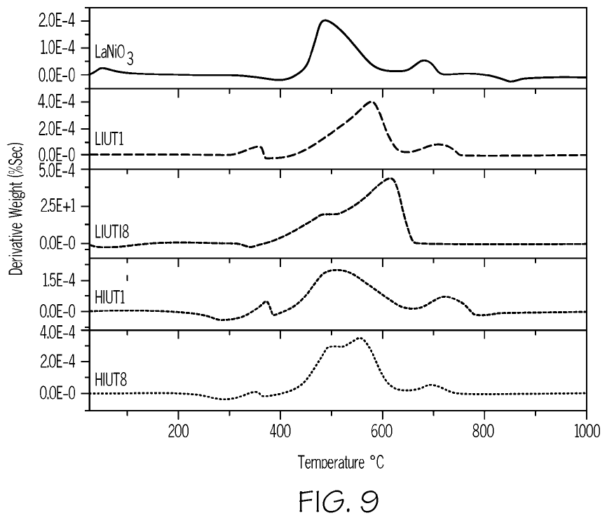

According to the DTA and the data shown in FIG. 9, all catalysts show DTA peaks at various temperatures, indicating that the various types of carbon deposits with different reactivities coexist in the spent samples. LIUT1, HIUT1 and HIUT8 show three main peaks: a small one appearing at 350° C., a broad peak within the 400-600° C. range (which seems to result from presence of various overlapping peaks), and a smaller one centered at 720° C. The reference LaNiO₃ catalyst only shows the two peaks at higher temperature, centered at 450 and 700° C., while the most stable catalyst, LIUT8 only shows the broad peak centered at 580° C.

Carbon deposits burning at higher temperatures are less active, and here all catalysts except for the more stable LIUT8 catalyst show this peak, indicating that this higher temperature peak is probably associated with a type of carbon deposit that is detrimental to the catalyst in reaction. On the other hand, the asymmetric peak centered at 580° C. which appears in the LIUT8 catalyst indicates that most of the carbon deposits formed on this sample are assigned to this peak, and that it must correspond to a structured carbon species since the XRD pattern of this sample was the only one that showed an intense peak corresponding to a crystalline graphitic species. LIUT1 and HIUT8 also show this same DTA peak, despite their XRD patterns not showing the corresponding graphitic peak, however, it is possible that the quantity and/or size of this carbon species were too low to be detected by XRD.

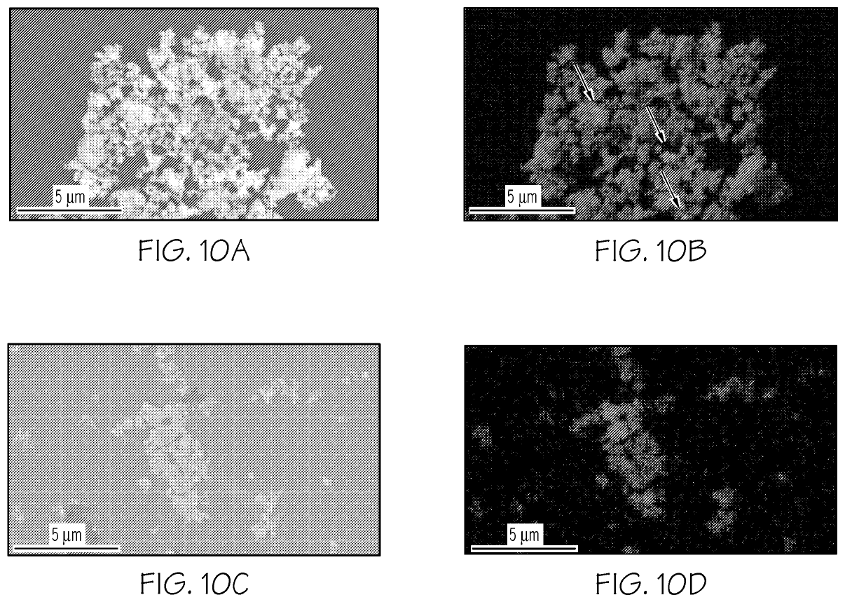

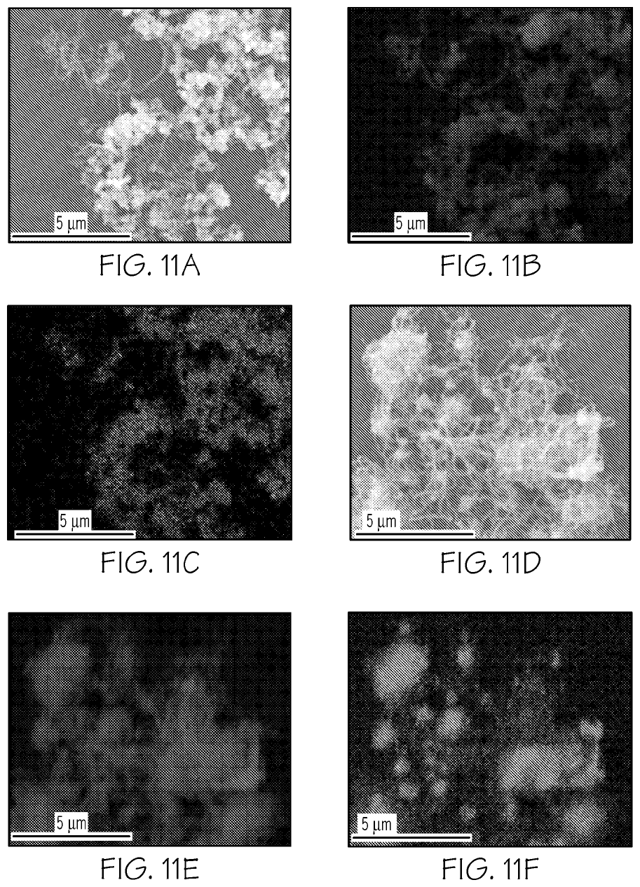

To further explore and contrast the morphology and elemental makeup of the highly active LIUT8 and reference LaNiO₃, scanning electron microscopy with energy dispersive spectroscopy (SEM-EDS) was performed on these two catalysts at different stages of reaction (FIGS. 10A-11F). The images of both activated samples LaNiO₃ and LIUT8, FIGS. 10A and 10B respectively, indicate that metallic Ni(0) particles are well dispersed, although some particle aggregation is observed in certain areas showing brighter spots (indicated by arrows in the figures). This effect is more intense in the reference LaNiO₃ catalyst. In the SEM micrographs of the spent LaNiO₃ and reference LIUT8 catalysts (FIGS. 11A and 11D respectively) it is observed that the latter presented a large density of nanofibers, while the reference sample presents much smaller quantities of nanofibers, aligning with the results observed by TGA quantification and XRD.

Elemental mapping for carbon in both of these spent catalysts (after 3 h of reaction) shown in FIGS. 11B and 11E indicates that in both cases the fibers are composed of carbon. In the case of reference LaNiO₃ not only is the amount of carbon nanofibers smaller than in LIUT8, but more importantly the carbon present seems to be amorphous, in agreement with the absence of crystalline carbon peaks in its diffraction pattern (FIG. 7), while the larger presence of carbon nanofibers is in accord with the presence of the graphitic peak in the XRD pattern for spent LIUT8 (FIG. 7).

Considering that LIUT8 is a more active catalyst, it is not surprising that more carbon product was formed and visibly detected on it, while the reference LaNiO₃ catalyst deactivated so quickly that it could not produce much carbon product. This faster deactivation of reference LaNiO₃ could be associated to the presence of amorphous Ni-encapsulating carbon. Elemental mapping of Ni in the spent catalysts also corroborates the findings from XRD analysis of spent samples (Table 2). Despite its higher activity and stability, LIUT8 shows a higher degree of Ni agglomeration over time, as evidenced by the crystal sizes Applicant calculated from XRD, and as can be observed by visual inspection of FIG. 11F.

Back scattering data was collected for both spent LaNiO₃ and LIUT8 (FIGS. 12A-12E) in order to examine the relative location of the Ni(0) active site with respect to the carbon produced on both catalysts. In these images, the heavier elements are represented by the brighter areas in the images, while lighter elements constitute the darker areas. It is observed that for LIUT8 (FIG. 12D) the fibrous carbon grows out of the brighter spots corresponding to Ni(0) active sites, while for LaNiO₃ (FIG. 12E) the Ni particles seem to be more segregated from the carbon nanofibers, suggesting that only a fraction of the Ni sites are acting as sites for carbon growth. This relative distribution of Ni and carbon in LIUT8 and LaNiO₃ agrees with the idea that in the case of LIUT8 more exsolved Ni is available on the catalyst surface, thus activating more methane (higher conversion) and providing more sites for carbon nanofiber growth.

FIGS. 12A-12E display images of spent LIUT8 catalysts with increasing TOS at 30 minutes, 1 hour, and 2 hours of reaction respectively, showing how over time the carbon nanofibers continuously grow from exposed Ni particles. Moreover, these images seem to indicate that the Ni sites remain exposed on the carbon nanotubes during their growth, raising the possibility that the interaction of these Ni sites with the carbon nanotubes act as secondary catalytic sites for further methane decomposition, explaining the observed rise in methane conversion over time for LIUT8 (FIG. 2).

### Example 1.7. Conclusions

Ni-based perovskites are attractive catalyst candidates for the production of COₓ-free hydrogen via methane decomposition given their superior stability under harsh reaction conditions. The high stability is achieved via the strong metal-support interactions established between exsolved Ni sites and the La₂O₃ support after catalyst pre-reduction, which is thought to hinder sintering of the active sites over time. Despite the stability advantage, LaNiO₃ suffers from low activity given its low surface area as well as the small exposure of the active, reduced Ni sites formed after pre-reduction of these catalysts.

In this Example, Applicant demonstrates that the presence of defects in the LaNiO₃ catalyst plays an important role in the mechanism of exsolution of Ni during catalyst pretreatment in reducing conditions. Applicant employed a sonochemical method that allows the modulation of the types of defects formed in the LaNiO₃ crystals, and Applicant determined that it is possible to, with the aid of ultrasound radiation, create defects in the form of NiO inclusions in the LaNiO₃ structure. These inclusions facilitate the exsolution and migration of the reduced Ni species to the surface of the catalyst particles, as is evidenced by the increased porosity of the La₂O₃ support after reduction, and SEM imaging, where they are better exposed to the reactant, thereby improving the catalytic activity of these materials. These exsolved Ni sites also steer the reaction towards production of structured carbon fibers (nanotubes) in lieu of amorphous encapsulating carbon products, further enhancing the catalyst durability, and potentially forming a solid carbon product that seems to exhibit autocatalytic behavior which allows for increased and maintained catalyst activity for more than 16 hours.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A lanthanum nickel oxide (LaNiO₃) perovskite, wherein the LaNiO₃ perovskite comprises a crystal structure, and wherein the crystal structure comprises nickel oxide (NiO) inclusions.

2. The LaNiO₃ perovskite of claim 1, wherein the LaNiO₃ perovskite has a surface area of less than about 23 m²/g.

3. The LaNiO₃ perovskite of claim 1, wherein the LaNiO₃ perovskite has a surface area ranging from about 10 m²/g to about 22 m²/g.

4-6. (canceled)

7. The LaNiO₃ perovskite of claim 1, wherein the LaNiO₃ perovskite crystal structure comprises a crystal size of less than about 23 nm.

8-11. (canceled)

12. The LaNiO₃ perovskite of claim 1, wherein the NiO inclusions are within the crystal structure and represent defects within the crystal structure.

13. (canceled)

14. The LaNiO₃ perovskite of claim 1, wherein the LaNiO₃ perovskite is operable to convert hydrocarbons to hydrogen without the formation of COₓ byproducts, wherein x represents an integer of 1 or higher.

15. The LaNiO₃ perovskite of claim 1, wherein the LaNiO₃ perovskite is a component of a catalytic conversion system comprising:
an inlet operable for receiving hydrocarbons;
a housing unit comprising the LaNiO₃ perovskite, wherein the LaNiO₃ perovskite is operable to convert the hydrocarbons to hydrogen; and
an outlet for outputting the formed hydrogen.

16. A method of forming a lanthanum nickel oxide (LaNiO₃) perovskite, said method comprising:
combining a lanthanum precursor and a nickel precursor to form a mixture; and
sonicating the mixture to form the LaNiO₃ perovskite, wherein the LaNiO₃ perovskite comprises a crystal structure, and wherein the crystal structure comprises nickel oxide (NiO) inclusions.

17. The method of claim 16, wherein the lanthanum precursor comprises lanthanum nitrate La(NO₃)₃.

18. The method of claim 16, wherein the nickel precursor comprises nickel nitrate Ni(NO₃).

19. The method of claim 16, wherein the lanthanum precursor and the nickel precursor are mixed at a molar ratio of 1:1.

20. The method of claim 16, wherein the lanthanum precursor and the nickel precursor are mixed at a molar ratio of 3:1.

21. The method of claim 16, wherein the sonicating occurs for a period of time ranging from about 30 minutes to about 24 hours.

22. (canceled)

23. The method of claim 16, wherein the sonicating occurs for at least about 30 minutes.

24-25. (canceled)

26. The method of claim 16, wherein the sonicating occurs at an ultrasound frequency ranging from about 10 kHz to about 200 kHz.

27-29. (canceled)

30. The method of claim 16, wherein the sonicating occurs at an ultrasonic power density of at least about 300 W/L.

31-32. (canceled)

33. The method of claim 16, wherein the sonicating occurs at an ultrasonic power density of less than about 50 W/L.

34. The method of claim 16, wherein the sonicating occurs at an ultrasonic power density of less than about 20 W/L.

35. The method of claim 16, wherein the LaNiO₃ perovskite has a surface area of less than about 23 m²/g.

36. The method of claim 16, wherein the LaNiO₃ perovskite has a surface area ranging from about 10 m²/g to about 22 m²/g.

37. The method of claim 16, wherein the LaNiO₃ perovskite crystal structure comprises a crystal size of less than about 23 nm.

38. (canceled)

39. The method of claim 16, wherein the NiO inclusions are within the crystal structure and represent defects within the crystal structure.

40. (canceled)

41. The method of claim 16, wherein the LaNiO₃ perovskite is operable to convert hydrocarbons to hydrogen without the formation of COₓ byproducts, wherein x represents an integer of 1 or higher.

42. A method of catalytically converting a hydrocarbon to hydrogen, said method comprising:
exposing the hydrocarbon to lanthanum nickel oxide (LaNiO₃) perovskite, wherein the LaNiO₃ perovskite comprises a crystal structure, wherein the crystal structure comprises nickel oxide (NiO) inclusions, and wherein the LaNiO₃ perovskite catalytically converts the hydrocarbon to hydrogen.

43. The method of claim 42, wherein the hydrocarbon comprises methane.

44. The method of claim 42, wherein the LaNiO₃ perovskite catalytically converts the hydrocarbon to hydrogen without the formation of COₓ byproducts, wherein x represents an integer of 1 or higher.

45. The method of claim 42, wherein the LaNiO₃ perovskite catalytically converts the hydrocarbon to hydrogen without the formation of CO₂.

46. The method of claim 42, wherein the LaNiO₃ perovskite has a surface area of less than about 23 m²/g.

47. The method of claim 42, wherein the LaNiO₃ perovskite has a surface area ranging from about 10 m²/g to about 22 m²/g.

48. The method of claim 42, wherein the LaNiO₃ perovskite crystal structure comprises a crystal size of less than about 23 nm.

49. (canceled)

50. The method of claim 42, wherein the NiO inclusions are within the crystal structure and represent defects within the crystal structure.

51. (canceled)
